(19) United States
(12) Patent Application Publication
(10) Pub. No.: US 2016/0329020 A1
(43) Pub. Date: Nov. 10, 2016

(54) FRONTLIGHT SYSTEM WITH MULTIPLE ANGLE LIGHT-TURNING FEATURES

(71) Applicant: QUALCOMM MEMS Technologies, Inc., San Diego, CA (US)

(72) Inventors: Jian Ma, San Diego, CA (US); Zheng-wu Li, Milpitas, CA (US); Chung-Po Huang, San Jose, CA (US); John Hyunchul Hong, San Clemente, CA (US)

(21) Appl. No.: 14/703,630

(22) Filed: May 4, 2015

(51) Int. Cl. G09G 3/34; F21V 7/04; F21V 7/00; F21V 8/00

(52) U.S. Cl. CPC G09G 3/3466; G02B 6/0035; G02B 6/0055; F21V 7/04; F21V 7/0025

(57) ABSTRACT

This disclosure provides systems, methods and apparatus for light-guiding layers including light-turning features with multiple reflective surfaces oriented at different angles to the light-guiding layer. In one aspect, the multiple reflective surfaces may be located on each individual light-turning feature, while in another aspect, the multiple reflective surfaces may be located on separate light-turning features. The use of multiple reflective surfaces oriented at different angles can improve the efficiency and appearance of a frontlight system using such a light-guiding layer.

### TECHNICAL FIELD

This disclosure relates to frontlight systems, and in particular frontlight systems which can be used alone or in conjunction with reflective displays.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of EMS device is called an interferometric modulator (IMOD). The term IMOD or interferometric light modulator refers to a device that selectively absorbs and/or reflects light using the principles of optical interference. In some implementations, an IMOD display element may include a pair of conductive plates, one or both of which may be transparent and/or reflective, wholly or in part, and capable of relative motion upon application of an appropriate electrical signal. For example, one plate may include a stationary layer deposited over, on or supported by a substrate and the other plate may include a reflective membrane separated from the stationary layer by an air gap. The position of one plate in relation to another can change the optical interference of light incident on the IMOD display element. IMOD-based display devices have a wide range of applications, and are anticipated to be used in improving existing products and creating new products, especially those with display capabilities.

### SUMMARY

The systems, methods and devices of this disclosure each have several innovative aspects, no single one of which is solely responsible for the desirable attributes disclosed herein.

One innovative aspect of the subject matter described in this disclosure can be implemented in a light-turning structure comprising a light-guiding layer including a first generally planar surface and a second generally planar surface; and a plurality of reflective light-turning features extending into the light-guiding layer and adjacent the first surface of the light-guiding layer, each of the plurality of reflective light-turning features having a sidewall including a first reflective surface proximal the first surface of the light-guiding layer, oriented at a first angle relative to a normal of the first surface of the light-guiding layer; and a second reflective surface distal the first surface of the light-guiding layer from the first reflective surface, wherein at least a portion of the second reflective surface is oriented at a second angle to the normal of the first surface of the light-guiding layer, the second angle larger than the first angle.

In some implementations, the second reflective surface can be conical. In some implementations, the second reflective surface can be a portion of a frustum extending from the distal edge of the first reflective surface. In some implementations, the second reflective surface can be curved. In some implementations, the plurality of reflective light-turning features can have an ellipsoidal cross-section. In some implementations, each of the plurality of reflective light-turning features can be rotationally symmetric about an axis orthogonal to the first surface of the light-guiding layer.

In some implementations, each of the plurality of reflective light-turning features can include a masking layer; and a reflective layer located between the light-turning layer and the masking layer. In some further implementations, the masking layer can be opaque and less reflective than the reflective layer. In some further implementations, the masking layer can cover the side of the reflective layer facing the masking layer. In some implementations, the light-turning layer can include a first material, and the structure can additionally include a cladding layer formed over the first surface of the light-turning layer, wherein the cladding layer is formed from a second material, and wherein the index of refraction of the first material is greater than the index of refraction of the second material.

Another innovative aspect of the subject matter described in this disclosure can be implemented in a reflective display device, comprising an array of reflective display elements; and a frontlight system configured to illuminate the array of reflective display elements, the frontlight system including a light-guiding layer having a first edge, a first generally planar surface, and a second generally planar surface; a light source configured to inject light into the light-guiding layer through the first edge of the light-guiding layer; and a plurality of light-turning features configured to reflect light out of the light-guiding layer through the second surface of the light-guiding layer and towards the array of reflective display elements, the plurality of light-turning features including a first plurality of reflective surfaces facing the first edge of the light-guiding layer and oriented at a first angle to the first surface of the light-guiding layer and a second plurality of reflective surface facing the first edge of the light-guiding layer and oriented at a second angle to the first surface of the light-guiding layer.

In some implementations, the second reflective surface can be conical. In some implementations, the second reflective surface can be a portion of a frustum extending from the distal edge of the first reflective surface. In some implementations, the second reflective surface can be curved. In some implementations, the plurality of light-turning features can include a first subset of light-turning features including the first plurality of reflective surfaces, and a second subset of light-turning features including the second plurality of reflective surfaces.

Another innovative aspect of the subject matter described in this disclosure can be implemented in a light-turning structure comprising a light-guiding layer configured to constrain light propagating therein via total internal reflection, the light-guiding layer having a first edge, a first generally planar surface, and a second generally planar surface; first light-turning means for turning light last reflected off of the first generally planar surface towards the second generally surface at an angle which allows the reflected light to pass through the second generally planar surface; and second light-turning means for turning light last reflected off the second generally planar surface towards the second generally planar surface at an angle which allows the reflected light to pass through the second generally planar surface.

In some implementations, the structure can include a plurality of reflective light-turning features extending into the light-guiding layer and adjacent the first surface of the light-guiding layer, wherein: the first light-turning means can include a reflective surface of the plurality of light-turning features located proximal the first generally planar surface and oriented at a first angle relative to a normal of the first surface of the light-guiding layer; and the second light-turning means can include a second reflective surface of the plurality of light-turning features located distal the first generally planar surface of the light-guiding layer from the first reflective surface, wherein at least a portion of the second reflective surface is oriented at a second angle to the normal of the first surface of the light-guiding layer, the second angle larger than the first angle.

In some implementations, the structure can include a plurality of reflective light-turning features extending into the light-guiding layer and adjacent the first surface of the light-guiding layer, wherein the plurality of reflective light-turning features can include a first subset of light-turning features and a second subset of light-turning features; the first light-turning means includes a reflective surface of the first subset of light-turning features, oriented at a first angle relative to a normal of the first surface of the light-guiding layer; and the second light-turning means can include a reflective surface of the second subset of light-turning features, oriented at a second angle relative to a normal of the first surface of the light-guiding layer, the second angle larger than the first angle.

Details of one or more implementations of the subject matter described in this disclosure are set forth in the accompanying drawings and the description below. Although the examples provided in this disclosure are primarily described in terms of EMS and MEMS-based displays the concepts provided herein may apply to other types of displays such as liquid crystal displays, organic light-emitting diode (“OLED”) displays, and field emission displays. Other features, aspects, and advantages will become apparent from the description, the drawings and the claims. Note that the relative dimensions of the following figures may not be drawn to scale.

### BRIEF DESCRIPTION OF THE DRAWINGS

FIG. 1A shows a side cross-section of an example of a frontlight system configured to turn incident light out of plane of the frontlight system.

FIG. 1B shows a side cross-section of the example frontlight system of FIG. 1A surrounded by cladding layers.

FIG. 2 shows a side cross-section of the frontlight system of FIG. 1B, illustrating differences in reflected angle depending on the path of incident light rays.

FIG. 3 is an example plot of the intensity of light exiting a frontlight system as a function of angle to the normal.

FIG. 4A is a side cross-section of a frontlight system which includes light-turning features with multiple reflective surfaces.

FIG. 4B is an example plot of the intensity of light exiting the frontlight system of FIG. 4A as a function of angle to the normal.

FIG. 5 is a detail view of a light-turning feature of the frontlight system of FIG. 4A.

FIG. 6 is a detail view of another implementation of a light-turning feature with multiple reflective surfaces, in which one of the surfaces is curved.

FIG. 7 is a side cross-section of a frontlight system which includes multiple types of light-turning features.

FIG. 8 is a flow diagram illustrating a fabrication process for a multilayer structure including light-turning features oriented at multiple angles.

FIG. 9 is a cross-sectional view of a display device including a frontlight system which includes light-turning features having reflective surfaces oriented at multiple angles.

FIG. 10 is an isometric view illustration depicting two adjacent interferometric modulator (IMOD) display elements in a series or array of display elements of an IMOD display device.

FIGS. 11A and 11B are system block diagrams illustrating a display device that includes a plurality of IMOD display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (e.g., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

In order to illuminate a reflective display or other object, a frontlight system can be disposed over the object to be illuminated. Light can be injected from the side of the frontlight system and into a light-guiding film. The light can propagate within the light-guiding film until it strikes a reflective light-turning feature and is reflected downward and out of the light-guiding film to illuminate the underlying object. As light propagates within the light-guiding film, many rays may be reflected off of at least one of the upper or lower planar surfaces of the light-guiding film before striking a surface of a reflective-light turning feature. The angle of incidence will depend on whether the light ray last reflected off of the upper or lower planar surface. By providing light-turning features with multiple reflective surfaces on the same side of a single light-turning feature, each of the reflective surfaces can be oriented at an angle optimized to turn light reflected off of a different one of the upper or lower planar surfaces of the light-guiding film.

Particular implementations of the subject matter described in this disclosure can be implemented to realize one or more of the following potential advantages. By concentrating multiple reflection conditions at near-normal to the major surfaces of the frontlight system, the overall efficiency of the frontlight system can be improved as a larger amount of light can be turned out of the system to illuminate an underlying object. In addition, because the concentration of light turned out of the system at a near-normal angle is increased, the reduction in light emitted at large angles to the normal can be reduced, improving the contrast ratio of a display. When light-turning features include multiple reflective surfaces on the same light-turning feature, the light-turning features can be embossed deeper into the light guiding layer, improving the efficiency of the frontlight system without increasing the footprint of the light-turning features.

An example of a suitable EMS or MEMS device or apparatus, to which the described implementations may apply, is a reflective display device. Reflective display devices can incorporate interferometric modulator (IMOD) display elements that can be implemented to selectively absorb and/or reflect light incident thereon using principles of optical interference. IMOD display elements can include a partial optical absorber, a reflector that is movable with respect to the absorber, and an optical resonant cavity defined between the absorber and the reflector. In some implementations, the reflector can be moved to two or more different positions, which can change the size of the optical resonant cavity and thereby affect the reflectance of the IMOD. The reflectance spectra of IMOD display elements can create fairly broad spectral bands that can be shifted across the visible wavelengths to generate different colors. The position of the spectral band can be adjusted by changing the thickness of the optical resonant cavity. One way of changing the optical resonant cavity is by changing the position of the reflector with respect to the absorber. Other reflective display devices can include, for instance, reflective liquid crystal displays (LCDs) and e-ink displays.

In certain implementations, frontlight systems can be used to provide primary or supplemental illumination for a reflective display device or other object to be illuminated. In particular, reflective display devices such as interferometric modulator-based devices or other electromechanical system (EMS) devices may utilize frontlight systems for illumination due to the opacity of the EMS devices. While a reflective display such as an interferometric modulator-based display may in some implementations be visible in ambient light, some particular implementations of reflective displays may include supplemental lighting in the form of a frontlight system.

In some implementations, a frontlight system may include one or more light-guiding films or layers through which light can propagate, and one or more light-turning features to direct light out of the light-guiding layers. Light can be injected into the light-guiding layer, and light-turning features can be used to reflect light within the light-guiding layer towards the reflective display and reflected back by the display through the light-guiding layer towards a viewer. Until light reaches a light-turning feature, the injected light may propagate within the light-guiding layer by means of total internal reflection so long as the material of the light-guiding layer has an index of refraction sufficiently greater than that of the surrounding layers. Such a frontlight system allows an illuminating light source to be positioned at a location offset from the display or other object to be illuminated, such as at one of the edges of the frontlight system.

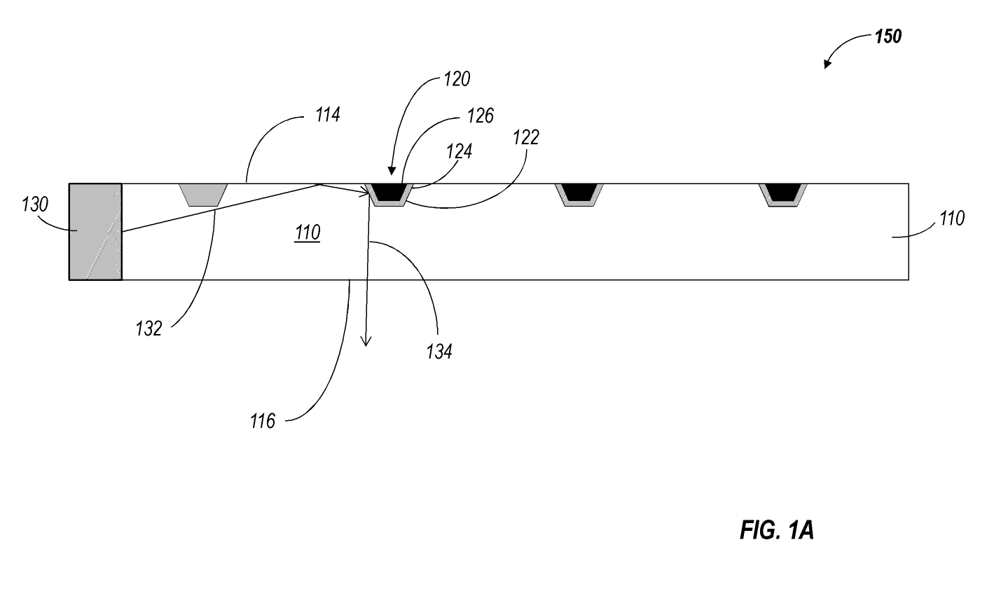

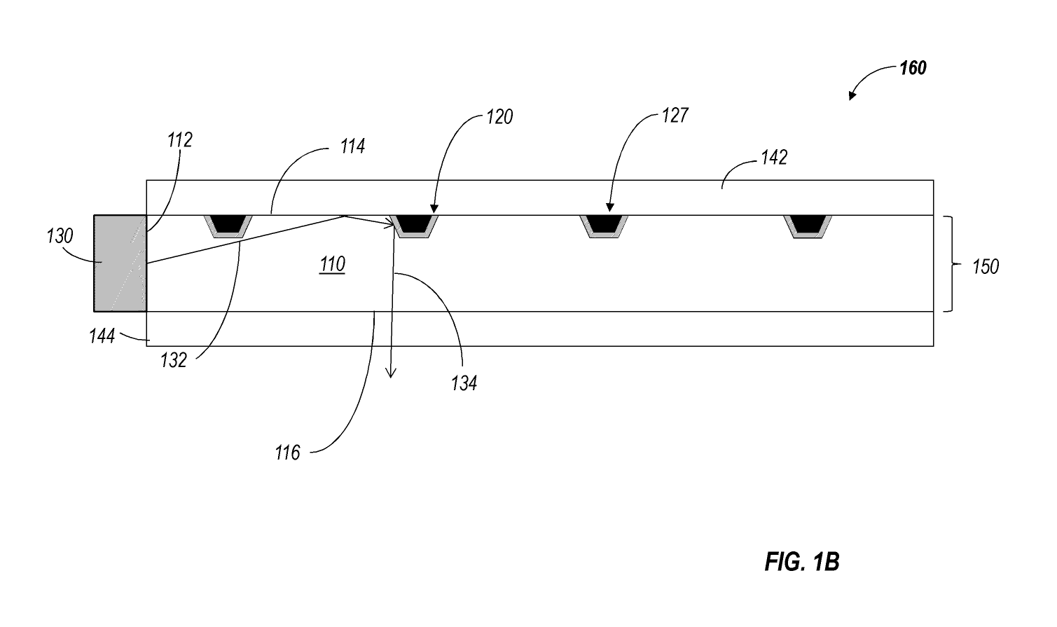

FIG. 1A shows a side cross-section of an example of a frontlight system configured to turn incident light out of plane of the frontlight system. The frontlight system 150 includes a light-guiding layer 110 which may have an index of refraction greater than air or any surrounding layers, as discussed above. The light-guiding layer 110 also may include a plurality of light-turning features 120 disposed along an upper surface 114 of the light-guiding layer 110.

These light-turning features 120 include a reflective layer 124 formed over a depression in the light-guiding layer 110. The depression may be conical or frustoconical in shape, such that the portion of the reflective layer 124 in contact with an angled sidewall of the depression forms a reflective surface 122 oriented at an angle to the upper surface 114 and lower surface 116 of light-guiding layer 110. The light-turning features also may include a masking layer or masking layers 126 disposed on the opposite side of the reflective layer 124 as the light-turning film 110. In some implementations, masking layer 126 can be an opaque black material, such as black photoresist, carbon nanoparticles, or silver nanoparticles, which can absorb most of the light incident upon the masking layer 126. In such implementations, masking layer 126 will prevent ambient light incident on the upper surface of the reflective layer 124 not facing away from the light-guiding layer 110 from being reflected by the reflective layer 124. The frontlight system 150 also includes one or more light sources such as LED 130 disposed adjacent an edge 112 of the light-guiding layer 110.

The LED 130 injects light ray 132 into the light-guiding film 110, which propagates by means of total internal reflection as shown until it strikes a reflective surface 122 of a light-turning feature 120. The light ray 134 reflected off the reflective surface 122 of the light-turning feature 120 is turned downwards towards lower surface 116 of the light-guiding layer 110. When the light ray 134 is reflected in a direction sufficiently close to the normal of the lower surface 116 of light-guiding layer 110, the light ray 134 passes through the lower surface 116 of light-guiding layer 110 without being reflected back into the light-guiding layer 110.

In the illustrated implementation, all light incident upon the angled reflective surface 122 will be reflected by reflected surface 122 turned downwards towards lower surface 116 of the frontlight film 110. In contrast, in frontlight systems which rely on total internal reflection at the angled surfaces of similar light-turning features, the reflection or transmission of light reaching the angled surfaces of similar light-turning features may be dependent on the angle at which the light 132 is incident upon a reflective surface of a light-turning feature. The use of a reflective layer 124 can therefore reduce light leakage from light-turning features 120, improving the efficiency of the frontlight system 150 as a larger amount of light can be directed downward and towards a reflective display or other object to be illuminated.

Although referred to for convenience as a frontlight film 110, the frontlight film 110 may in some implementations be a multilayer structure formed from layers having indices of refraction sufficiently close to one another that the frontlight film 110 generally functions as a single film, with minimal refraction and/or total internal reflection between the various sublayers of the frontlight film 110.

The frontlight system 150 thus redirects light 132 propagating within the light-guiding layer downward through the lower surface 116 of the light-guiding system 110. As illustrated in FIG. 1A, the frontlight system relies on the interface between air and the planar sections of the upper surface 114 and the lower surface 116 of frontlight film 110 to constrain light 134 propagating within the frontlight film 110 via total internal reflection (TIR). However, a frontlight system is often used as part of a multilayer structure, and contact between the frontlight film 110 and an adjacent high-index material may frustrate the total internal reflection and prevent the frontlight system 150 from operating as intended.

FIG. 1B shows a side cross-section of the example frontlight system of FIG. 1A surrounded by cladding layers. In some implementations, similar total internal reflection performance can be achieved by surrounding the light-guiding layer 110 with an upper cladding layer 142 and a lower cladding layer 144. The upper cladding layer 142 and lower cladding layer 144 can be formed from a material which has an index of refraction sufficiently lower than the frontlight film 110. As can be seen in FIG. 1B, the upper cladding layer is formed over the upper surface 114 of the frontlight film 110 and is in contact with the planar portions of the upper surface 114 of the light-guiding layer 110 extending between the light-turning features 120, filling the depressions in the upper surface of the light-turning features 120. These contact areas form an interface between the lower-index upper cladding layer 142 and the planar sections of the higher-index light-guiding layer 110 in order to facilitate total internal reflection of light propagating within the light-guiding layer before it reaches a light-turning feature 120.

In the illustrated implementation, the light-turning features 120 are formed by coating a depression in the underlying light-guiding layer 110 with a layer 124 of reflective material, to ensure that all light 134 incident upon the light-turning features 120 is reflected. However, coating the light-turning features 120 generally requires a precise fabrication process, increasing the cost and complexity of the fabrication process. Even if the reflective layer is masked on the other side, the use of an opaque reflective material within a frontlight film can alter the appearance of the underlying display or object. If the size of the light-turning feature can be reduced, the effect on the appearance of the underlying object can be reduced. Due to alignment tolerances, a lithographically patterned light-turning feature 120 can include sections of a reflective layer 124 and masking layer 126 which are larger than the underlying depression 118 to ensure that the underlying depression is fully covered by the layers of the light-turning feature 120. in some implementations, the reflective layer 124 and the masking layer 126 can also be fabricated using a maskless process, where the reflective layer 124 and the masking layer 126 can be formed during the same process step or series of process steps which forms the depression 118 In such implementations, the dimensions of reflective layer 124 and masking layer 126 can be precisely aligned with the depression 118, such that outwardly extending sections of the reflective layer 124 and masking layer 126 need not be used to compensate for lithographic alignment tolerances.

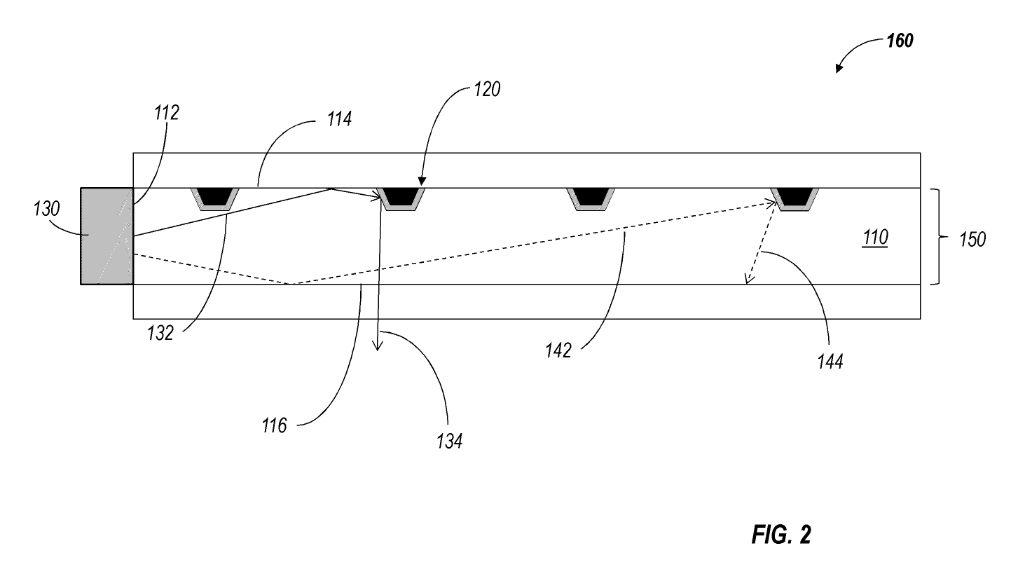

FIG. 2 shows a side cross-section of the frontlight system of FIG. 1B, illustrating differences in reflected angle depending on the path of incident light rays. In FIG. 2, the first light ray 132 is last reflected off of the upper surface 114 of the light-guiding layer 110 prior to being reflected off of the reflective surface 122 of the light-turning feature 120 and being redirected as light ray 134 out of the lower surface 116 of the light-guiding layer. In contrast, a second ray 142 is last reflected off of the lower surface 116 of the light-guiding layer 122, prior to being reflected off of the reflective surface 122 of the light-turning feature 120 and being redirected as light ray 144 towards the lower surface 116 of the light-guiding layer. Because of the different angles of incidence of the light rays 132 and 142 upon the reflective surface 122 of the light-turning feature 120, the reflected light rays 134 and 144 will reach the lower surface 116 of the light-guiding layer 110 at different angles.

The reflective surfaces 122 may in some implementations be oriented at an angle which optimizes the light-turning angle of light ray 132 and other light rays which reflect off the upper surface 114. In other implementations, the reflective surfaces 122 may be oriented at an angle which optimizes the light-turning angle of light ray 142 and other light rays which reflect off the lower surface 116. In an implementation in which the angles of the reflective surfaces 122 are optimized for reflection of light rays 132 which last reflected off of the upper surface 114, the reflected light rays 134 will be redirected towards the lower surface 116 of the light-guiding layer 110 in a direction which is orthogonal to the lower surface 116, or near-orthogonal. In contrast, the reflected light rays 144 will be redirected at a larger angle to the normal of the lower surface 116. Because the light ray 144 is incident upon the lower surface 116 at a larger angle to the normal than the light ray 134, reflected light rays 144 that pass through the lower surface 116 will illuminate an underlying object at an indirect angle. In such implementations, the amount of the energy in the normal direction (the typical viewing direction) may be reduced, resulting in reduced brightness. Similarly, if the reflective surfaces 122 of the light-turning features 120 were oriented at an angle which caused light rays 142 to be reflected as light rays 144 orthogonal or near-orthogonal to the lower surface 116, the light rays 134 would be incident upon the lower surface 116 at a larger angle to the normal.

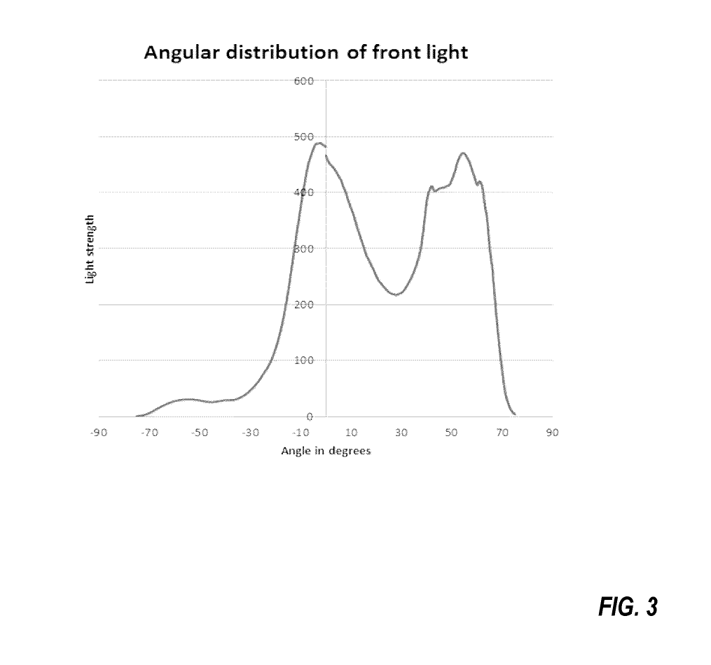

FIG. 3 is an example plot of the intensity of light exiting a frontlight system as a function of angle to the normal. Because of the differences in angles of incidence between light rays 132 last reflected off the upper surface 114 and light rays 134 last reflected off the lower surface 116, the angular distribution of light exiting the light-guiding layer 110 may have two distinct peaks. While one of those peaks can be aligned with the normal, the photon energy in the second peak of similar intensity at an off-normal angle has little contribution to the display brightness and is wasted.

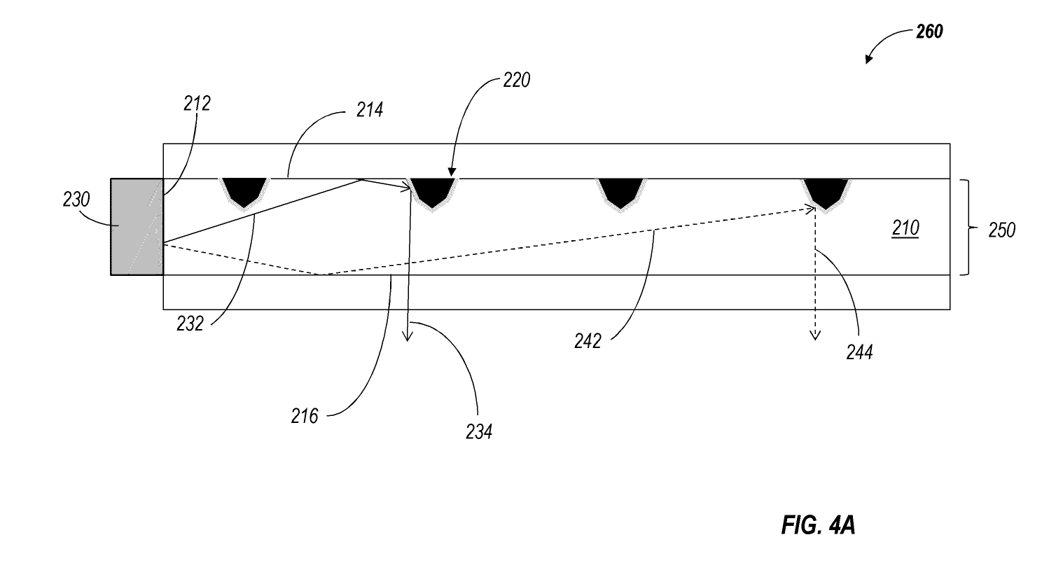

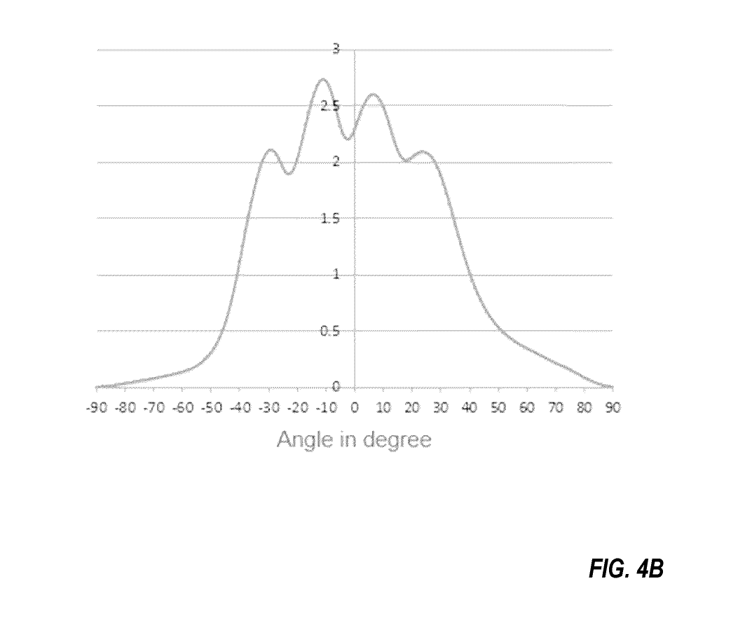

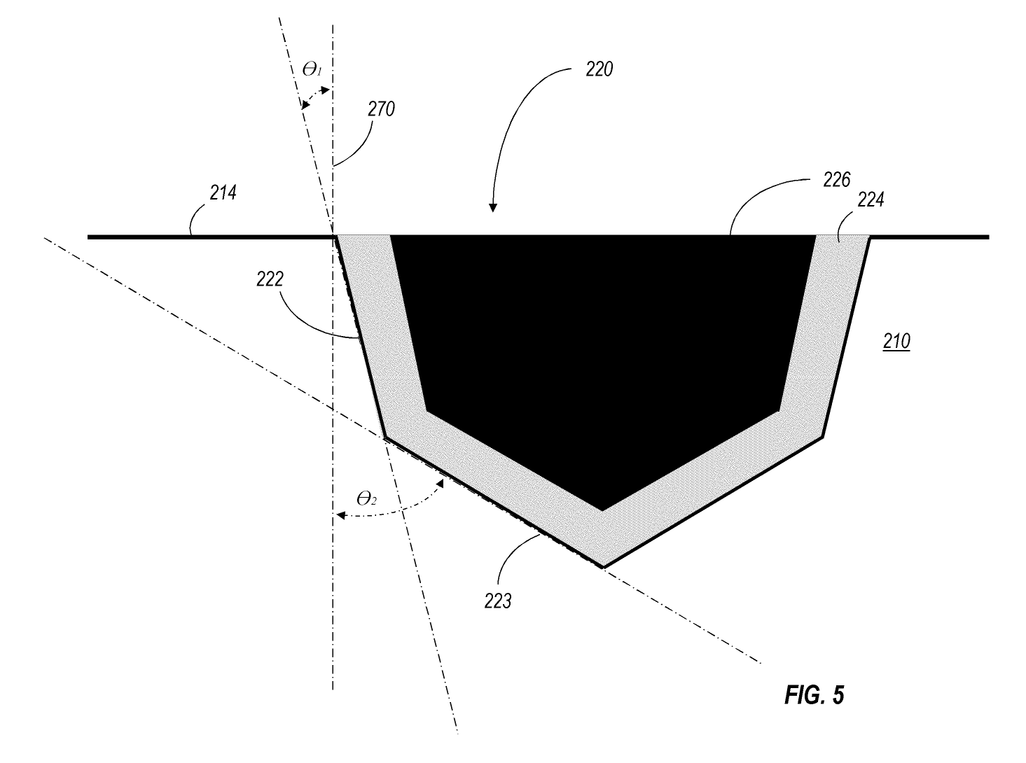

FIG. 4A is a side cross-section of a frontlight system which includes light-turning features with multiple reflective surfaces. The frontlight system 250 includes a light-guiding layer 210 surrounded on both sides by an upper cladding layer 242 and a lower cladding layer 244, respectively. A light source 230 adjacent an edge 212 of the light-guiding layer 210 injects light into the light-guiding layer 210, where it propagates until it strikes a light-turning feature 220. The light-turning feature 220 has multiple reflective surfaces, including a first reflective surface 222 proximal the upper surface 214 of the light-guiding layer 210 and a second reflective surface 223 located distal of the first reflective surface 222 from the upper surface 214 of the light-guiding layer 210. As discussed in greater detail below with respect to FIG. 5, the first reflective surface 222 located closer to the upper surface 214 of the light-guiding layer 210 is oriented at a first angle to the normal of the upper surface 214 which is smaller than the second angle that the second reflective surface 223 makes with the normal of the upper surface 214.

As can be seen in FIG. 4, a first light ray 232 which reflects off of the upper surface 214 of the light-guiding layer 210 immediately prior to reaching the light-turning feature 220 is turned downward toward the lower surface 216 of the light-guiding layer 210 at an angle which is generally orthogonal or near-orthogonal to the plane of the lower surface 216. Similarly, a second light ray 234 which reflects off of the lower surface 216 of the light-guiding layer 210 immediately prior to reaching the light-turning feature 220 will also, if it strikes the second reflective surface 223 of the light-turning feature 220, be turned downward toward the lower surface 216 of the light-guiding layer 210 at an angle which is generally orthogonal or near-orthogonal to the plane of the lower surface 216.

A light ray such as light ray 232 which last reflects off of the upper surface 214 of the light-guiding layer 210 may be reflected at a larger angle to the normal of the lower surface 216 of the light-guiding layer 210 if the light ray is reflected off of the second reflective surface 223 of the light-turning feature 220. Similarly, a light ray such as light ray 234 which last reflects off of the lower surface 216 of the light-guiding layer 210 may be reflected at a larger angle to the normal of the lower surface 216 if it strikes the second reflective surface 223 of the light-turning feature 220. As discussed above, the turning of light at a larger angle to the normal of the lower surface 216 of the light-guiding layer 210 can result in an overall reduction of an amount of light reflected at a significant angle to the normal of the lower surface 216. However, since the second reflective surface 223 is deeper than the first reflective surface 222, it is more likely to intersect light rays reflected from lower surface 216 of the light-guiding layer 210 than rays reflected from upper surface 214 of the light-guiding layer 210. The second reflective surface 223 thus provides light-turning means for turning light last reflected off of the lower surface 216 towards the lower surface 216 at an angle which allows the reflected light to pass through the lower surface 216. Likewise, reflective surface 222 is more likely to intersect rays reflected from surface 214 than that reflected from surface 216. The first reflective surface 222 thus provides light-turning means for turning light last reflected off of the upper surface 214 towards the lower surface 216 at an angle which allows the reflected light to pass through the lower surface 216. Consequently, the frontlight system 260 of FIG. 4 is more efficient at normal or near-normal illumination than the frontlight system 160 of FIG. 1B.

FIG. 4B is an example plot of the intensity of light exiting the frontlight system of FIG. 4A as a function of angle to the normal. In contrast to the plot of FIG. 3, the angular distribution of light shown in FIG. 4B is generally centered about the normal, and does not include the between-peak spacing which causes the prominent off-normal peak of FIG. 3. The use of light-turning features with reflective surfaces at multiple angles causes the off-normal peak of FIG. 3 to be shifted towards the normal, resulting in increased symmetry. Because rays reflected from upper surface 214 are more likely to be reflected by first reflective surface 222 and rays reflected from lower surface 216 are more likely to be reflected by second reflective surface 223, the resulting angular light distribution is more symmetrical.

Although the implementation of FIG. 4A is described with respect to optimizing the multiple reflective surfaces to concentrate near-normal reflection of light rays totally internally reflected off the upper surface 214 and the lower surface 216, other implementations may be optimized to concentrate near-normal reflection of other light rays. For example, in another implementation, the reflective surfaces can be arranged to concentrate near-normal reflection of light rays which travel directly to the light turning feature 220, along with either light rays totally internally reflected off the upper surface 214 or light rays totally internally reflected off of the lower surface 216. In addition, in some implementations the light-turning feature can include more than two reflective surfaces oriented at various angles to the substrate. For example, in one specific implementation, the light-turning feature can include three reflective surfaces, arranged to concentrate near-normal reflection of light rays which travel directly to the light-turning feature 220, light rays totally internally reflected off of the upper surface 214, and light rays totally internally reflected off of the lower surface 216, respectively.

FIG. 5 is a detail view of a light-turning feature of the frontlight system of FIG. 4A. It can also be seen in FIG. 5 that the masking layer 226 of the light-turning feature 220 fills the depression within the reflective layer 224. As discussed in greater detail below, the shape and thickness of the masking layer 226 may differ based on the manufacturing techniques used to form the light-turning features 220.

It can also be seen in FIG. 5 that the first reflective surface 222 makes an angle θ₁ with the normal 270 of the upper surface 214 of the light-guiding layer 210. The second reflective surface makes an angle θ₂ with the normal 270 of the upper surface 214 of the light-guiding layer 210, where the angle θ₂ is larger than the angle θ₁.

In the illustrated implementation, it can be seen that the light-turning feature tapers to a point at its lower end, with the first reflective surface 222 having a shape defined by the outer tapering sidewall of a frustum, and with the second reflective surface 223 having a conical shape. In other implementations (not shown), the second reflective surface may also be in the form of the outer tapering sidewall of a frustum, and the light-turning feature may have a flat base, rather than tapering to a point.

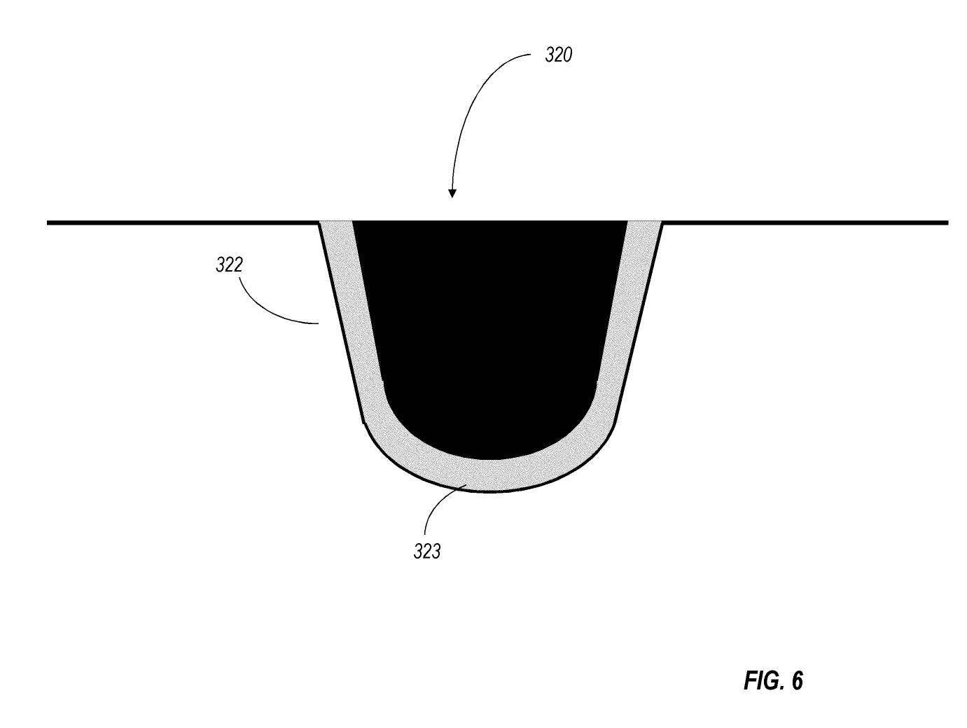

FIG. 6 is a detail view of another implementation of a light-turning feature with multiple reflective surfaces, in which one of the surfaces is curved. The light-turning feature 320 includes a first reflective surface 322 and a second reflective surface 323. In contrast to the light-turning feature 220 of FIGS. 4 and 5, the second reflective surface 323 is a nonlinear, curved surface. In the illustrated implementation, the second reflective surface is dome-shaped, so that the base of the light-turning feature 220 is curved. The curved reflective surface 323 thus provides an alternative light-turning means for turning light last reflected off of the lower surface of the light-guiding layer towards the lower surface at an angle which allows the reflected light to pass through the lower surface.

In some implementations, there may be a corner between the first reflective surface 322 and the second reflective surface 323, as shown. However, in other implementations, the first reflective surface 322 may transition more smoothly into the second reflective surface 323. In the illustrated implementation, the first reflective surface 322 is linear in cross-section, but in other implementations, either or both of the first and second reflective surfaces 322 and 323 may be curved. The curvature may be convex as shown, but may also be concave. In some implementations, the curvature may be less than the curvature illustrated in FIG. 6, while in other implementations the curvature of the curved section or sections may be greater.

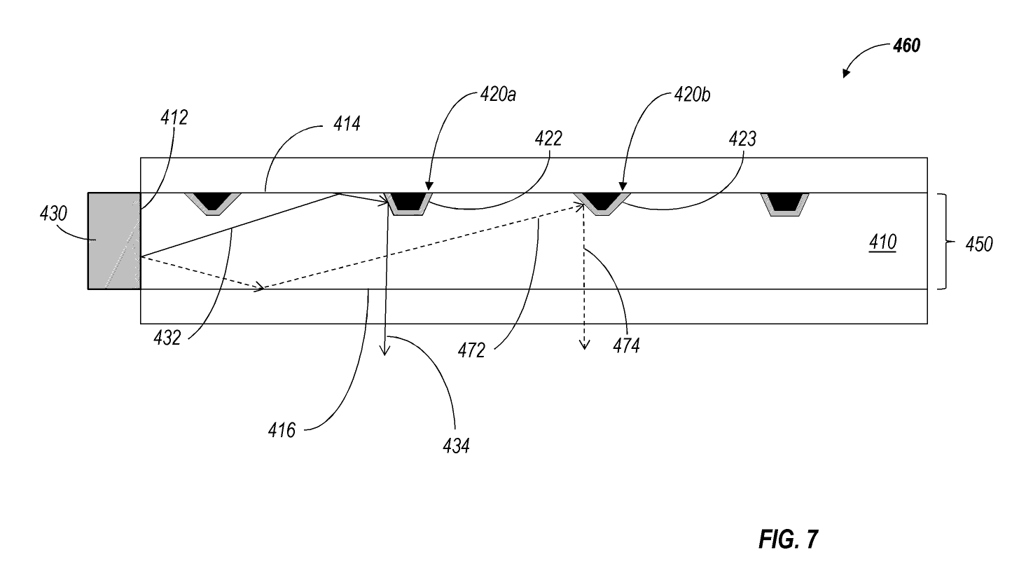

FIG. 7 is a side cross-section of another frontlight system which includes multiple types of light-turning features. The frontlight system 460 of FIG. 7 is similar to the frontlight system 260 of FIG. 4, but differs in that the frontlight system 460 of FIG. 7 includes two different types of light-turning features. A first type of light-turning feature 420a is in the form of a frustum having a sidewall with a reflective surface 422 oriented at a first angle to the upper surface 414 of the light-guiding layer 410. A second type of light-turning feature 420b also in the form of a frustum having a sidewall with a reflective surface 423, but the reflective surface 423 of the light turning features 420b is oriented at a different angle to the upper surface 414 of the light-guiding layer 410. Unlike the frontlight system 260 of FIG. 4, the frontlight system 460 include reflective surfaces configured to concentrate reflections at near-normal of light rays 432 which are totally internally reflected off of the upper surface 414 of the light-guiding layer 410 and light rays 472 which is totally internally reflected off of the lower surface 416 of the light-guiding layer 410 to the light turning feature 420b. As discussed above, any other combination of light rays can be concentrated at the near-normal through appropriate orientation of the reflective surfaces 422 and 423.

Because of the different orientations of the reflective surfaces 422 and 423, a light ray 432 last reflected off of the upper surface 414 of the light-guiding layer 410 is re-directed by the reflective surface 422 of a light-turning feature 420a at an angle near normal to the lower surface 416 of the light-guiding layer 410 and any underlying objects to be illuminated, such as a display panel of a reflective display, Similarly, a light ray 474 last reflected off of the lower surface 416 of the light-guiding layer 410 is re-directed by the reflective surface 423 of a light-turning feature 420b at an angle near normal to the lower surface 416 of the light-guiding layer 410 and any underlying objects to be illuminated, such as a display panel of a reflective display. The angles of reflective surfaces 422 and 423 can be chosen such that a second off-normal peak reflected from both surfaces is shifted to the positive angle and the negative angle, resulting in a broad symmetric viewing profile, such as that shown in FIG. 4B. The first reflective surface 422 provides light-turning means for turning light last reflected off of the upper surface 414 towards the lower surface 416 at an angle which allows the reflected light to pass through the lower surface 416, and the second reflective surface 423 provides light-turning means for turning light incident directly on the light-turning feature at an angle which allows the reflected light to pass through the lower surface 416

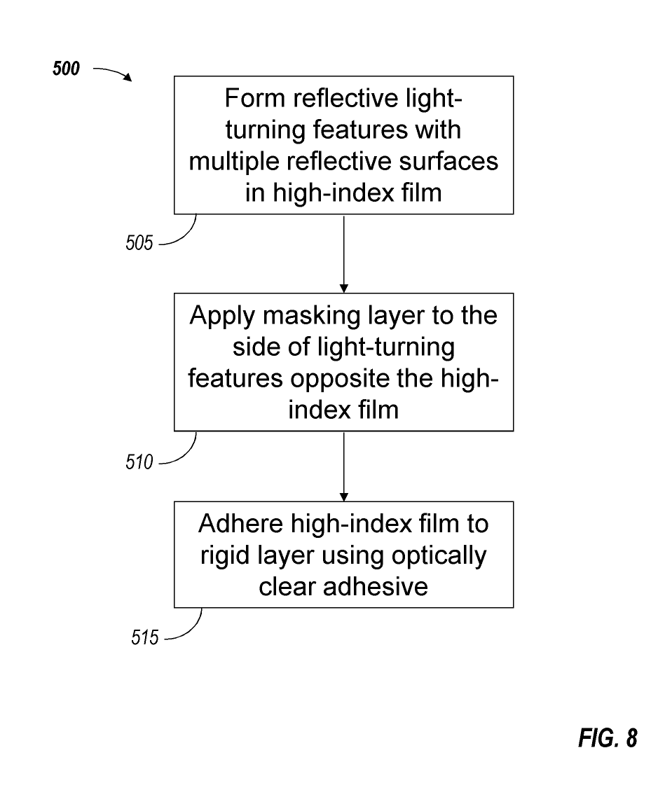

FIG. 8 is a flow diagram illustrating a fabrication process for a multilayer structure including light-turning features oriented at multiple angles. In block 505 of the fabrication process 500, a plurality of light-turning features are formed in a film having a high index of refraction, the light-turning features including reflective surfaces oriented at multiple angles. The high-index film can be a plastic film such as a polycarbonate, and depressions corresponding to the shape of the plurality of light-turning features can be embossed or stamped into the high-index film using a roll-to-roll process or other suitable fabrication process. In an implementation in which the light-turning features have a conical base, or otherwise taper inward, the light-turning features can be made deeper than light-turning features in the shape of a simple frustum. These deeper light-turning features can more efficiently turn light out of the high-index film, and can do so without increasing the footprint of the light-turning feature itself.

A reflective layer such as aluminum or an aluminum alloy can be fabricated via thin film deposition technique onto the high-index layer to cover the surfaces of the depressions in the high-index film to form the reflective surfaces. Other fabrication processes can also be used to achieve conformal metallization of the surfaces of the depression. In some implementations, the metallization can cover the entire upper surface of the high-index film at one point in the fabrication process, and the metal over the planar surfaces between the light-turning features can be removed by any suitable process, including electrochemical processes and topographical selective demetallization using a high energy source to provide local heating.

In block 510 of the fabrication process 500, the reflective layer of the light-turning feature is masked to prevent the upper surface of the reflective layer from reflecting light directly back towards a viewer, causing undesirable optical effects. In some implementations, the mask may be an opaque material, such as a dark or black photoresist. In some implementations, a self-aligned photolithographic process can be used to pattern the photoresist, with the reflective material of the light-turning features used as a mask for the overlying photoresist. In some implementations, the masking material filling the light-turning feature can be etched back or otherwise planarized to roughly the level of the upper surface of the high-index film.

In block 515 of the fabrication process 500, the high-index film can be adhered to a more rigid layer with a same or lower index of refraction. In some implementations, the rigid layer can be, for example, a plastic substrate or a glass substrate, but other suitable materials may also be used. An adhesive material can be used with an index of refraction the same or lower to that of the high-index layer and higher than the rigid layer, or between the indices of refraction of the high-index layer and the rigid layer.

Additional layers such as lower-index cladding layers may also be applied. An antireflective coating can in some implementations be applied, and may be done prior to the application of the low-index cladding layers. Additional layers, including touch systems, may be applied after application of the low-index cladding layer. The multilayer structure may also be adhered to or secured relative to a display substrate to form part of a frontlight system.

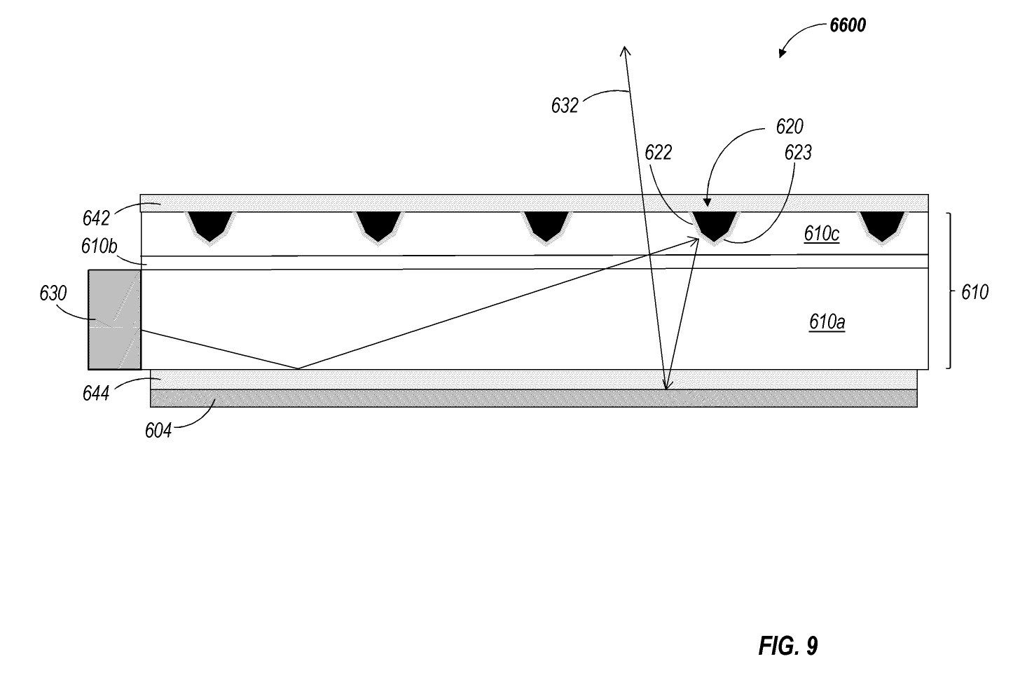

FIG. 9 is a cross-sectional view of a display device including a frontlight system which includes light-turning features having reflective surfaces oriented at multiple angles. In the implementation of FIG. 9, the light-guiding layer 610 is a multilayer structure, including a display substrate 610a, a light-turning sublayer 610c in which the light-turning features 620 are formed, and an optically clear adhesive 610b securing the display substrate 610a to the light-turning sublayer 610c.

In some implementations, the display substrate 610a may include glass, and may have a refractive index of roughly 1.53. The light-turning sublayer 610c is formed from a high-index material with an index of refraction higher than the substrate 610a, and may in some implementations be a layer of polycarbonate with an index of refraction of roughly 1.58. The light-turning sublayer 4610c is also sufficiently thick that the asymmetrical light-turning features 620 can be formed therein, and may in some implementations be roughly 100 um thick. The adhesive layer 610b may be formed of an optically clear adhesive having an index of refraction between the indices of refraction of the display substrate 610a and the light-turning sublayer 610c, and may in some implementations have an index of refraction between about 1.53 and 1.55. Other materials, thicknesses, and arrangements of layers may also be used, however.

In implementations such as the display device 600 of FIG. 9, in which a display substrate 610a forms a part of a multilayer light-guiding layer 610, a low-index lower cladding layer 644 may be disposed between the display substrate 410a and a reflective display 604 supported by the display substrate 610a. In some implementations, the lower cladding layer 644 may be formed prior to the formation of an array of reflective display elements such as interferometric modulators (discussed in greater detail below) which form part of the reflective display 604. In some implementations, the lower cladding layer 644 can be a layer of spin-on glass with a refractive index of less than 1.39, or a layer of silicon oxide (SiO2) with a refractive index or roughly 1.46 or 1.47, although other materials may also be used.

An upper cladding layer 642 is formed over the light-turning sublayer 610c. In some implementations, the light-turning sublayer 610c and upper cladding layer 642 may be a multilayer structure formed as part of a roll-to-roll process or other manufacturing process, and adhered to the display substrate 610a. Additional components may also be included in various implementations of display devices, such as an antireflective film, a touch-sensing system, and a protective cover glass.

The above implementations of frontlight systems and components may be used to illuminate a wide variety of objects, including but not limited to reflective displays. One non-limiting example of a reflective display type with which the frontlight systems and components described herein may be used is an interferometric modulator (IMOD) based display.

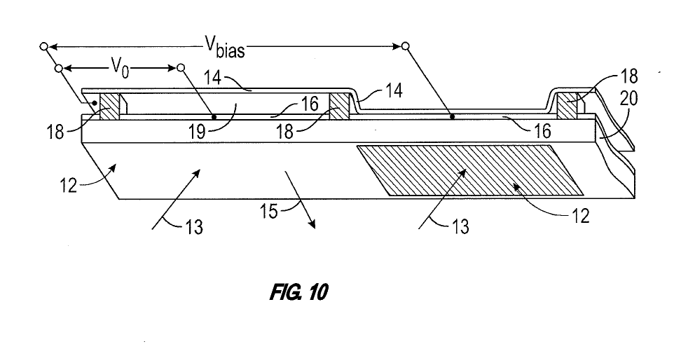

FIG. 10 is an isometric view illustration depicting two adjacent interferometric modulator (IMOD) display elements in a series or array of display elements of an IMOD display device. The IMOD display device includes one or more interferometric EMS, such as MEMS, display elements. In these devices, the interferometric MEMS display elements can be configured in either a bright or dark state. In the bright (“relaxed,” “open” or “on,” etc.) state, the display element reflects a large portion of incident visible light. Conversely, in the dark (“actuated,” “closed” or “off,” etc.) state, the display element reflects little incident visible light. MEMS display elements can be configured to reflect predominantly at particular wavelengths of light allowing for a color display in addition to black and white. In some implementations, by using multiple display elements, different intensities of color primaries and shades of gray can be achieved.

The IMOD display device can include an array of IMOD display elements which may be arranged in rows and columns. Each display element in the array can include at least a pair of reflective and semi-reflective layers, such as a movable reflective layer (i.e., a movable layer, also referred to as a mechanical layer) and a fixed partially reflective layer (i.e., a stationary layer), positioned at a variable and controllable distance from each other to form an air gap (also referred to as an optical gap, cavity or optical resonant cavity). The movable reflective layer may be moved between at least two positions. For example, in a first position, i.e., a relaxed position, the movable reflective layer can be positioned at a distance from the fixed partially reflective layer. In a second position, i.e., an actuated position, the movable reflective layer can be positioned more closely to the partially reflective layer. Incident light that reflects from the two layers can interfere constructively and/or destructively depending on the position of the movable reflective layer and the wavelength(s) of the incident light, producing either an overall reflective or non-reflective state for each display element. In some implementations, the display element may be in a reflective state when unactuated, reflecting light within the visible spectrum, and may be in a dark state when actuated, absorbing and/or destructively interfering light within the visible range. In some other implementations, however, an IMOD display element may be in a dark state when unactuated, and in a reflective state when actuated. In some implementations, the introduction of an applied voltage can drive the display elements to change states. In some other implementations, an applied charge can drive the display elements to change states.

The depicted portion of the array in FIG. 10 includes two adjacent interferometric MEMS display elements in the form of IMOD display elements 12. In the display element 12 on the right (as illustrated), the movable reflective layer 14 is illustrated in an actuated position near, adjacent or touching the optical stack 16. The voltage V_{bias} applied across the display element 12 on the right is sufficient to move and also maintain the movable reflective layer 14 in the actuated position. In the display element 12 on the left (as illustrated), a movable reflective layer 14 is illustrated in a relaxed position at a distance (which may be predetermined based on design parameters) from an optical stack 16, which includes a partially reflective layer. The voltage V₀ applied across the display element 12 on the left is insufficient to cause actuation of the movable reflective layer 14 to an actuated position such as that of the display element 12 on the right.

In FIG. 10, the reflective properties of IMOD display elements 12 are generally illustrated with arrows indicating light 13 incident upon the IMOD display elements 12, and light 15 reflecting from the display element 12 on the left. Most of the light 13 incident upon the display elements 12 may be transmitted through the transparent substrate 20, toward the optical stack 16. A portion of the light incident upon the optical stack 16 may be transmitted through the partially reflective layer of the optical stack 16, and a portion will be reflected back through the transparent substrate 20. The portion of light 13 that is transmitted through the optical stack 16 may be reflected from the movable reflective layer 14, back toward (and through) the transparent substrate 20. Interference (constructive and/or destructive) between the light reflected from the partially reflective layer of the optical stack 16 and the light reflected from the movable reflective layer 14 will determine in part the intensity of wavelength(s) of light 15 reflected from the display element 12 on the viewing or substrate side of the device. In some implementations, the transparent substrate 20 can be a glass substrate (sometimes referred to as a glass plate or panel). The glass substrate may be or include, for example, a borosilicate glass, a soda lime glass, quartz, Pyrex, or other suitable glass material. In some implementations, the glass substrate may have a thickness of 0.3, 0.5 or 0.7 millimeters, although in some implementations the glass substrate can be thicker (such as tens of millimeters) or thinner (such as less than 0.3 millimeters). In some implementations, a non-glass substrate can be used, such as a polycarbonate, acrylic, polyethylene terephthalate (PET) or polyether ether ketone (PEEK) substrate. In such an implementation, the non-glass substrate will likely have a thickness of less than 0.7 millimeters, although the substrate may be thicker depending on the design considerations. In some implementations, a non-transparent substrate, such as a metal foil or stainless steel-based substrate can be used. For example, a reverse-IMOD-based display, which includes a fixed reflective layer and a movable layer which is partially transmissive and partially reflective, may be configured to be viewed from the opposite side of a substrate as the display elements 12 of FIG. 10 and may be supported by a non-transparent substrate.

The optical stack 16 can include a single layer or several layers. The layer(s) can include one or more of an electrode layer, a partially reflective and partially transmissive layer, and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals (e.g., chromium and/or molybdenum), semiconductors, and dielectrics. The partially reflective layer can be formed of one or more layers of materials, and each of the layers can be formed of a single material or a combination of materials. In some implementations, certain portions of the optical stack 16 can include a single semi-transparent thickness of metal or semiconductor which serves as both a partial optical absorber and electrical conductor, while different, electrically more conductive layers or portions (e.g., of the optical stack 16 or of other structures of the display element) can serve to bus signals between IMOD display elements. The optical stack 16 also can include one or more insulating or dielectric layers covering one or more conductive layers or an electrically conductive/partially absorptive layer.

In some implementations, at least some of the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of supports, such as the illustrated posts 18, and an intervening sacrificial material located between the posts 18. When the sacrificial material is etched away, a defined gap 19, or optical cavity, can be formed between the movable reflective layer 14 and the optical stack 16. In some implementations, the spacing between posts 18 may be approximately 1-1000 μm, while the gap 19 may be approximately less than 10,000 Angstroms (Å).

In some implementations, each IMOD display element, whether in the actuated or relaxed state, can be considered as a capacitor formed by the fixed and moving reflective layers. When no voltage is applied, the movable reflective layer 14 remains in a mechanically relaxed state, as illustrated by the display element 12 on the left in FIG. 10, with the gap 19 between the movable reflective layer 14 and optical stack 16. However, when a potential difference, i.e., a voltage, is applied to at least one of a selected row and column, the capacitor formed at the intersection of the row and column electrodes at the corresponding display element becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated display element 12 on the right in FIG. 10. The behavior can be the same regardless of the polarity of the applied potential difference. Though a series of display elements in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. In some implementations, the rows may be referred to as “common” lines and the columns may be referred to as “segment” lines, or vice versa. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

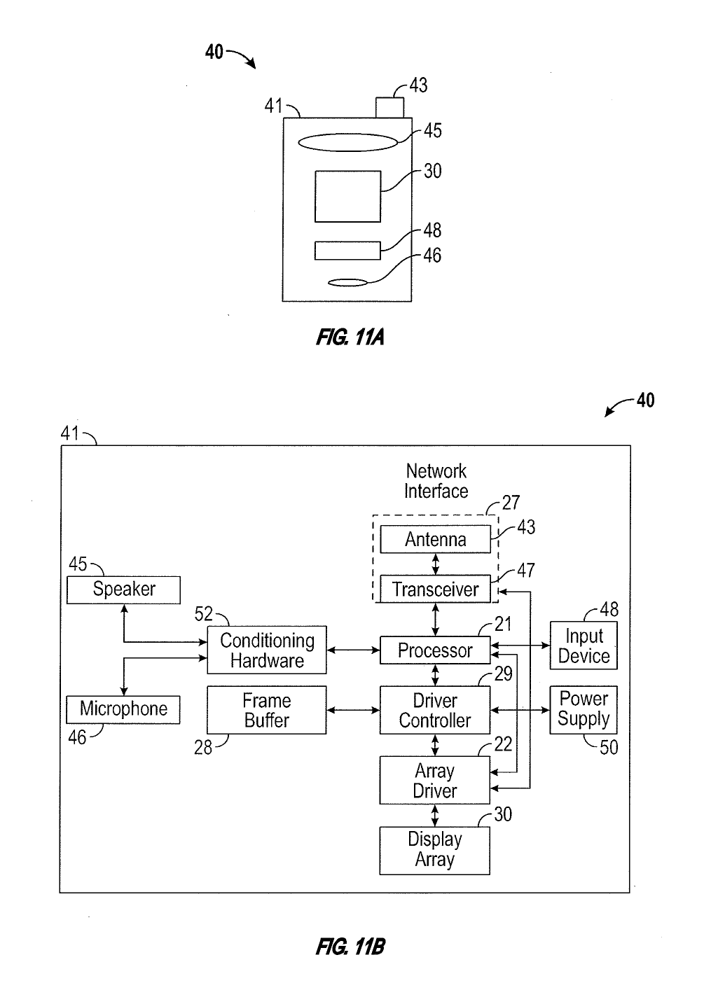

FIGS. 11A and 11B are system block diagrams illustrating a display device 40 that includes a plurality of IMOD display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an IMOD-based display, as described herein.

The components of the display device 40 are schematically illustrated in FIG. 11A. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 11A, can be configured to function as a memory device and be configured to communicate with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), NEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements.

In some implementations, the driver controller 29, the array driver 22, and the display array 30 are appropriate for any of the types of displays described herein. For example, the driver controller 29 can be a conventional display controller or a bi-stable display controller (such as an IMOD display element controller). Additionally, the array driver 22 can be a conventional driver or a bi-stable display driver (such as an IMOD display element driver). Moreover, the display array 30 can be a conventional display array or a bi-stable display array (such as a display including an array of IMOD display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of, e.g., an IMOD display element as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A light-turning structure comprising:
a light-guiding layer including a first generally planar surface and a second generally planar surface; and
a plurality of reflective light-turning features extending into the light-guiding layer and adjacent the first surface of the light-guiding layer, each of the plurality of reflective light-turning features having a sidewall including:
a first reflective surface proximal the first surface of the light-guiding layer, oriented at a first angle relative to a normal of the first surface of the light-guiding layer; and
a second reflective surface distal the first surface of the light-guiding layer from the first reflective surface, wherein at least a portion of the second reflective surface is oriented at a second angle to the normal of the first surface of the light-guiding layer, the second angle larger than the first angle.

2. The structure of claim 1, wherein the second reflective surface is conical.

3. The structure of claim 1, wherein the second reflective surface is a portion of a frustum extending from the distal edge of the first reflective surface.

4. The structure of claim 1, wherein the second reflective surface is curved.

5. The structure of claim 1, wherein the plurality of reflective light-turning features have an ellipsoidal cross-section.

6. The structure of claim 1, wherein each of the plurality of reflective light-turning features is rotationally symmetric about an axis orthogonal to the first surface of the light-guiding layer.

7. The structure of claim 1, wherein each of the plurality of reflective light-turning features includes:
a masking layer; and
a reflective layer located between the light-turning layer and the masking layer.

8. The structure of claim 7, wherein the masking layer is opaque and less reflective than the reflective layer.

9. The structure of claim 7, wherein the masking layer covers the side of the reflective layer facing the masking layer.

10. The structure of claim 1, wherein the light-turning layer includes a first material, the structure additionally including a cladding layer formed over the first surface of the light-turning layer, wherein the cladding layer is formed from a second material, and wherein the index of refraction of the first material is greater than the index of refraction of the second material.

11. A reflective display device, comprising:
an array of reflective display elements; and
a frontlight system configured to illuminate the array of reflective display elements, the frontlight system including:
a light-guiding layer having a first edge, a first generally planar surface, and a second generally planar surface;
a light source configured to inject light into the light-guiding layer through the first edge of the light-guiding layer; and
a plurality of light-turning features configured to reflect light out of the light-guiding layer through the second surface of the light-guiding layer and towards the array of reflective display elements, the plurality of light-turning features including a first plurality of reflective surfaces facing the first edge of the light-guiding layer and oriented at a first angle to the first surface of the light-guiding layer and a second plurality of reflective surface facing the first edge of the light-guiding layer and oriented at a second angle to the first surface of the light-guiding layer.

12. The reflective display device of claim 11, wherein the second reflective surface is conical.

13. The reflective display device of claim 11, wherein the second reflective surface is a portion of a frustum extending from the distal edge of the first reflective surface.

14. The reflective display device of claim 11, wherein the second reflective surface is curved.

15. The reflective display device of claim 11, wherein the plurality of light-turning features include a first subset of light-turning features including the first plurality of reflective surfaces, and a second subset of light-turning features including the second plurality of reflective surfaces.

16. The reflective display device of claim 11, additionally including:
a processor that is configured to communicate with the array of reflective display elements, the processor being configured to process image data; and
a memory device that is configured to communicate with the processor.

17. The reflective display device of claim 16, additionally including:
a driver circuit configured to send at least one signal to the array of reflective display elements; and
a controller configured to send at least a portion of the image data to the driver circuit.

18. The reflective display device of claim 16, additionally including an image source module configured to send the image data to the processor, wherein the image source module comprises at least one of a receiver, transceiver, and transmitter.

19. The reflective display device of claim 16, additionally including an input device configured to receive input data and to communicate the input data to the processor.

20. A light-turning structure comprising:
a light-guiding layer configured to constrain light propagating therein via total internal reflection, the light-guiding layer having a first edge, a first generally planar surface, and a second generally planar surface;
first light-turning means for turning light last reflected off of the first generally planar surface towards the second generally surface at an angle which allows the reflected light to pass through the second generally planar surface; and
second light-turning means for turning light last reflected off the second generally planar surface towards the second generally planar surface at an angle which allows the reflected light to pass through the second generally planar surface.

21. The structure of claim 20, wherein the structure includes a plurality of reflective light-turning features extending into the light-guiding layer and adjacent the first surface of the light-guiding layer, wherein:
the first light-turning means includes a reflective surface of the plurality of light-turning features located proximal the first generally planar surface and oriented at a first angle relative to a normal of the first surface of the light-guiding layer; and
the second light-turning means include a second reflective surface of the plurality of light-turning features located distal the first generally planar surface of the light-guiding layer from the first reflective surface, wherein at least a portion of the second reflective surface is oriented at a second angle to the normal of the first surface of the light-guiding layer, the second angle larger than the first angle.

22. The structure of claim 20, wherein the structure includes a plurality of reflective light-turning features extending into the light-guiding layer and adjacent the first surface of the light-guiding layer, wherein:
the plurality of reflective light-turning features includes a first subset of light-turning features and a second subset of light-turning features;
the first light-turning means includes a reflective surface of the first subset of light-turning features, oriented at a first angle relative to a normal of the first surface of the light-guiding layer; and
the second light-turning means includes a reflective surface of the second subset of light-turning features, oriented at a second angle relative to a normal of the first surface of the light-guiding layer, the second angle larger than the first angle.
